(19) United States
(12) Patent Application Publication
(10) Pub. No.: US 2023/0004016 A1
(43) Pub. Date: Jan. 5, 2023

(54) MULTI-AXIAL COLLIMATION OPTICS FOR LIGHT DETECTION AND RANGING

(71) Applicant: Seagate Technology LLC, Fremont, CA (US)

(72) Inventors: Daniel Joseph Klemme, Robbinsdale, MN (US); Daniel Aaron Mohr, Saint Paul, MN (US)

(21) Appl. No.: 17/844,402

(22) Filed: Jun. 20, 2022

Related U.S. Application Data
(60) Provisional application No. 63/218,046, filed on Jul. 2, 2021.

(51) Int. Cl. G02B 27/30; G01S 17/10; G01S 7/487; G01S 7/481

(52) U.S. Cl. CPC G02B 27/30; G01S 17/10; G01S 7/4876; G01S 7/4814

(57) ABSTRACT

Apparatus for collimating light in a light detection and ranging (LiDAR) system. A light source outputs a light beam for transmission to a target, such as a multi-mode source which generates an elongated beam with a higher diverging fast axis and a lower diverging slow axis. A refractive lens assembly collimates the light beam using a concave first cylindrical surface extending in facing relation toward the light source along the fast axis and a convex, second cylindrical surface facing away from the light source and extending along the slow axis orthogonal to the first cylindrical surface. A second refractive lens assembly distal from and orthogonal to the second cylindrical surface has a convex third cylindrical surface to further collimate the light beam along the fast axis. The elongated beam may diverge at a greater angle along the fast axis as compared to the slow axis.

### RELATED APPLICATION

The present application makes a claim of domestic priority to U.S. Provisional Patent No. 63/218,046 filed Jul. 2, 2021, the contents of which are hereby incorporated by reference.

### SUMMARY

Various embodiments of the present disclosure are generally directed to a method and apparatus for processing light ranging signals using multi-lens collimation techniques.

Without limitation, some embodiments provide an emitter having a light source that outputs a light beam for transmission to a target. The light source may be a multi-mode source which generates an elongated beam with orthogonal fast and slow axes. A refractive lens assembly collimates the light beam using a concave first cylindrical surface extending in facing relation toward the light source along the fast axis and a convex, second cylindrical surface facing away from the light source and extending along the slow axis orthogonal to the first cylindrical surface. A second refractive lens assembly distal from and orthogonal to the second cylindrical surface can have a convex third cylindrical surface to further collimate the light beam along the fast axis. The elongated beam may diverge at a greater angle along the fast axis as compared to the slow axis.

These and other features and advantages of various embodiments can be understood with a review of the following detailed description in conjunction with a review of the accompanying drawings.

### BRIEF DESCRIPTION OF THE DRAWINGS

FIG. 1 is a block representation of a Light Detection and Ranging (LiDAR) system constructed and operated in accordance with various embodiments of the present disclosure.

FIG. 2 is a simplified functional representation of an emitter constructed and operated in accordance with some embodiments.

FIGS. 3A and 3B show different output systems incorporated into an emitter such as in FIG. 2 in alternative embodiments.

FIG. 4 is a simplified functional representation of a detector constructed and operated in accordance with some embodiments.

FIG. 5 depicts an optical beam generated and used in accordance with various embodiments of the present disclosure.

FIGS. 6A and 6B show different divergence angles of the beam in FIG. 5 in some embodiments.

FIG. 7 is an optical collimation system constructed and operated in accordance with various embodiments.

FIG. 8A is a side elevational representation of a first optics assembly of the system of FIG. 7 in some embodiments.

FIG. 8B is a top plan view of the first optics assembly of FIG. 8A in some embodiments.

FIG. 9A is a side elevational representation of a second optics assembly of the system of FIG. 7 in some embodiments.

FIG. 9B is a top plan view of the second optics assembly of FIG. 9A in some embodiments.

FIG. 10 is a schematic depiction of another optical collimation system in accordance with further embodiments.

FIGS. 11A and 11B show respective front and rear facing views of a first optics assembly similar to those described above in some embodiments.

FIGS. 12A and 12B show respective front and rear facing views of a second optics assembly similar to those described above in some embodiments.

FIG. 13 shows a surface coating that can be applied to various optical surfaces described above in further embodiments.

FIG. 14 shows an adhesive layer used to adjoin separate optical elements into a combined assembly in accordance with some embodiments.

### DETAILED DESCRIPTION

Various embodiments of the present disclosure are generally directed to optimization of an active light detection system.

Light Detection and Ranging (LiDAR) systems are useful in a number of applications in which range information (e.g., distance, etc.) associated with a target is detected by irradiating the target with electromagnetic radiation in the form of light. The range information is detected in relation to timing and waveform characteristics of reflected light received back by the system. While not limiting, the light wavelengths used in a typical LiDAR system may range from ultraviolet to near infrared (e.g., 250 nanometers, nm to 1500 nm or more). Other wavelength ranges can be used.

One commonly employed form of LiDAR is sometimes referred to as coherent pulsed LiDAR, which generally uses coherent light and detects the range based on detecting phase differences in the reflected light. Such systems may use a dual (I/Q) channel detector with an I (in-phase) channel and a Q (quadrature) channel. Other forms of LiDAR systems can be used, however, including non-coherent light systems that may incorporate one or more detection channels. Further alternatives that can be incorporated into LiDAR systems include systems that sweep the emitted light using mechanical based systems that utilize moveable mechanical elements, solid-state systems with no moving mechanical parts but instead use phase array mechanisms to sweep the emitted light in a direction toward the target, and so on.

The term collimation generally refers to the extent to which light rays (e.g., photons/photon paths) are nominally parallel with one another. It is generally desirable to increase collimation (parallelism) and decrease divergence (scattering) within a light beam to enhance LiDAR performance. As a result, there remains a continued need for small sized, light weight and inexpensive emitter and detector configurations that provide tailored and well controlled beam characteristics including high levels of collimation and low levels of divergence. It is to these and other needs that various embodiments of the present disclosure are generally directed.

As described below, various embodiments provide an optical collimation system suitable for use in a LiDAR system. The collimation system includes a light source, a first optics assembly and a second optics assembly. A light beam emitted by the light source passes successively through the respective first and second optics assemblies to collimate the light beam along multiple orthogonal axes.

The collimation system has specially configured refraction features that diverge along one axis and converge along another orthogonal axis, allowing for better collimation power in a smaller amount of space. In some cases, multiple lenses may be adjoined into the optics assembly to carry out these functions. While the axes may be vertical and horizontal (e.g., X-Y), other arrangements can be provided depending on the requirements of a given application. Additional axes of collimation can be utilized as desired.

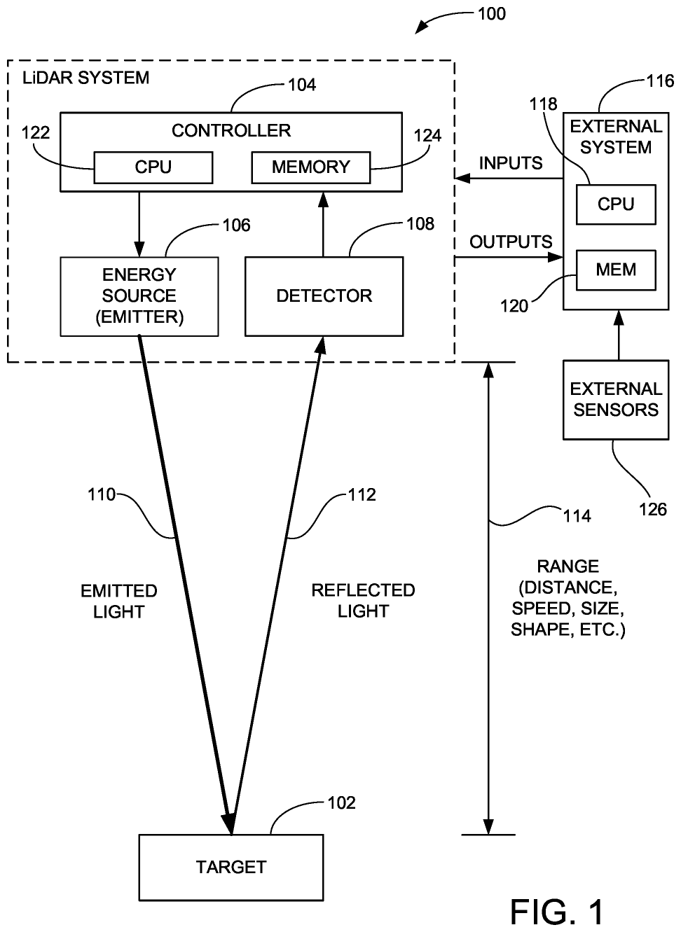

These and other features and advantages of various embodiments can be understood beginning with a review of FIG. 1, which provides a simplified functional representation of a LiDAR system 100 constructed and operated in accordance with various embodiments of the present disclosure. The LiDAR system 100 is configured to obtain range information regarding a target 102 that is located distal from the system 100. The information can be beneficial for a number of areas and applications including, but not limited to, topography, archeology, geology, surveying, geography, forestry, seismology, atmospheric physics, laser guidance, automated driving and guidance systems, closed-loop control systems, etc.

The LiDAR system 100 includes a controller 104 which provides top level control of the system. The controller 104 can take any number of desired configurations, including hardware and/or software. In some cases, the controller can include the use of one or more programmable processors with associated programming (e.g., software, firmware) stored in a local memory which provides instructions that are executed by the programmable processor(s) during operation. Other forms of controllers can be used, including hardware based controllers, digital signal processors (DSPs), field programmable gate arrays (FPGAs), system on chip (SOC) integrated circuits, application specific integrated circuits (ASICs), gate logic, reduced instruction set computers (RISCs), etc.

An energy source circuit 106, also sometimes referred to as an emitter or a transmitter, operates to direct electromagnetic radiation in the form of light pulses (beams) towards the target 102. A detector circuit 108, also sometimes referred to as a receiver or a sensor, senses reflected light pulses (beams) received back from the target 102. The controller 104 directs operation of the emitted light from the emitter 106, denoted by arrow 110, and decodes information from the reflected light obtained back from the target, as denoted by arrow 112.

Arrow 114 depicts the actual, true range information associated with the intervening distance (or other range parameter) between the LiDAR system 100 and the target 102. Depending on the configuration of the system, the range information can include the relative or absolute speed, velocity, acceleration, distance, size, location, reflectivity, color, surface features and/or other characteristics of the target 102 with respect to the system 100.

The decoded range information can be used to carry out any number of useful operations, such as controlling a motion, input or response of an autonomous vehicle, generating a topographical map, recording data into a data structure for further analysis and/or operations, etc. The controller 104 perform these operations directly, or can communicate the range information to an external system 116 for further processing and/or use.

In some cases, inputs supplied by the external system 116 can activate and configure the system to capture particular range information, which is then returned to the external system 116 by the controller 104. The external system can take any number of suitable forms, and may include a system controller (such as CPU 118), local memory 120, etc. The external system may form a portion of a closed-loop control system and the range information output by the LiDAR system 100 can be used by the external system 116 to adjust the position of a moveable element.

The controller 104 can incorporate one or more programmable processors (CPU) 122 that execute program instructions in the form of software/firmware stored in a local memory 124, and which communicate with the external controller 118. External sensors 126 can provide further inputs used by the external system 116 and/or the LiDAR system 100.

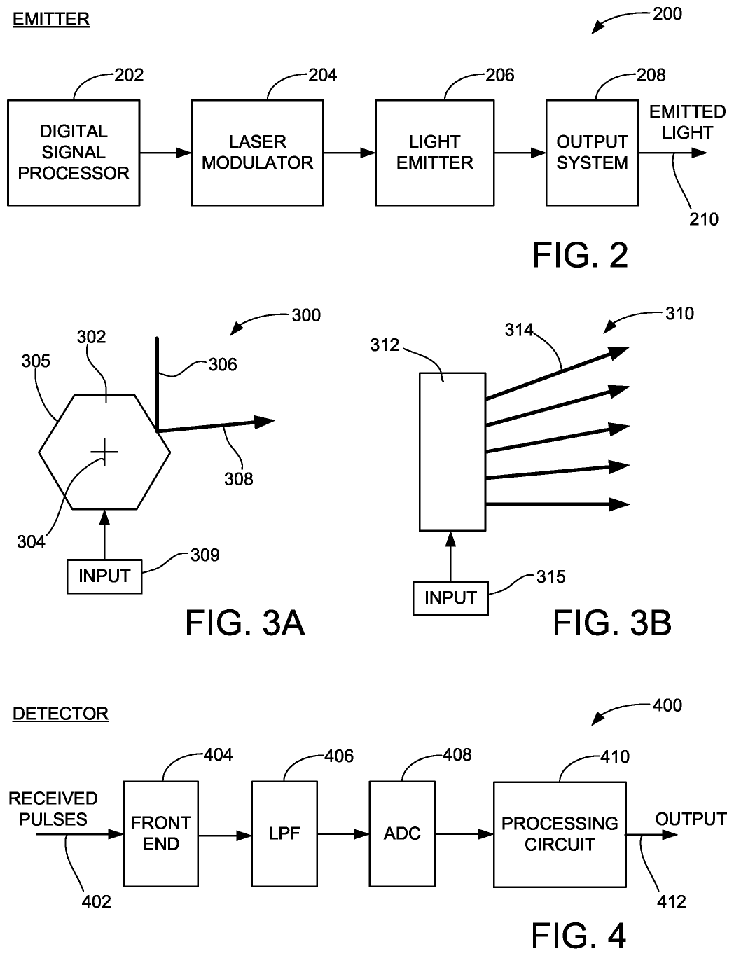

FIG. 2 depicts an emitter circuit 200 incorporated into the system 100 of FIG. 1 in some embodiments. Other arrangements can be used so the configuration of FIG. 2 is merely illustrative and is not limiting. The emitter circuit 200 includes a digital signal processor (DSP) that provides adjusted inputs to a laser modulator 204, which in turn adjusts a light emitter (e.g., a laser, a laser diode, etc.) that emits electromagnetic radiation (e.g. light) in a desired spectrum. The emitted light is processed by an output system 208 to issue and direct a beam of emitted light 210. The light may be in the form of pulses, coherent light, non-coherent light, swept light, etc. The output system 208 includes an optics collimation system that can be variously configured as described below.

FIGS. 3A and 3B show different aspects of some forms of output systems that can be used by the system of FIG. 2 to provide beam steering capabilities to rasterize the output light in a rasterized pattern over a selected field of view (FoV). Other arrangements can be used.

FIG. 3A shows a system 300 that includes a rotatable polygon 302 which is mechanically rotated about a central axis 304 at a desired rotational rate. The polygon 302 has reflective outer surfaces 305 adapted to direct incident light 306 as a reflected stream 308 at a selected angle responsive to the rotational orientation of the polygon 302. The polygon is characterized as a hexagon with six reflective sides, but any number of different configurations can be used. By coordinating the impingement of light 306 and rotational angle of the polygon 302, the output light 308 can be swept across the desired FoV. An input system 309, such as a closed loop servo system, can control the rotation of the polygon 302.

FIG. 3B provides a system 310 with a solid state array (integrated circuit device) 312 configured to emit light beams 314 at various selected angles across a desired FoV. Unlike the mechanical system of FIG. 3A, the solid state system of FIG. 3B has essentially no moving parts. As before, a closed loop input system 315 can be used to control the scan rate, density, etc. of the output light 314. Other arrangements can be used as desired, including DLP (micromirror) technology, galvanometers (galvos) that can impart localized deflection of lens arrangements to steer the beam, etc.

Regardless the configuration of the output system, FIG. 4 provides a generalized representation of a detector circuit 400 configured to process reflected light issued by the system of FIG. 2. The detector circuit 400 receives reflected pulses 402 which are processed by a suitable front end 404. The front end 404 can include a number of operational stages including optics, detector grids, amplifiers, mixers, and other suitable features to present input pulses reflected from the target. Multiple input detection channels can be utilized. The optics system used in FIG. 3 to transmit the light pulses can also be used to gather the reflected light pulses in FIG. 4, or separate optics systems can be used for emission and detection.

Continuing with FIG. 4, a low pass filter (LPF) 406 and an analog to digital converter (ADC) 408 filter and transform the input pulses to a form suitable for a processing circuit 410 to apply signal processing operations to generate a useful output 412. The processing circuit 410 can be incorporated into the various processors described above in FIG. 1.

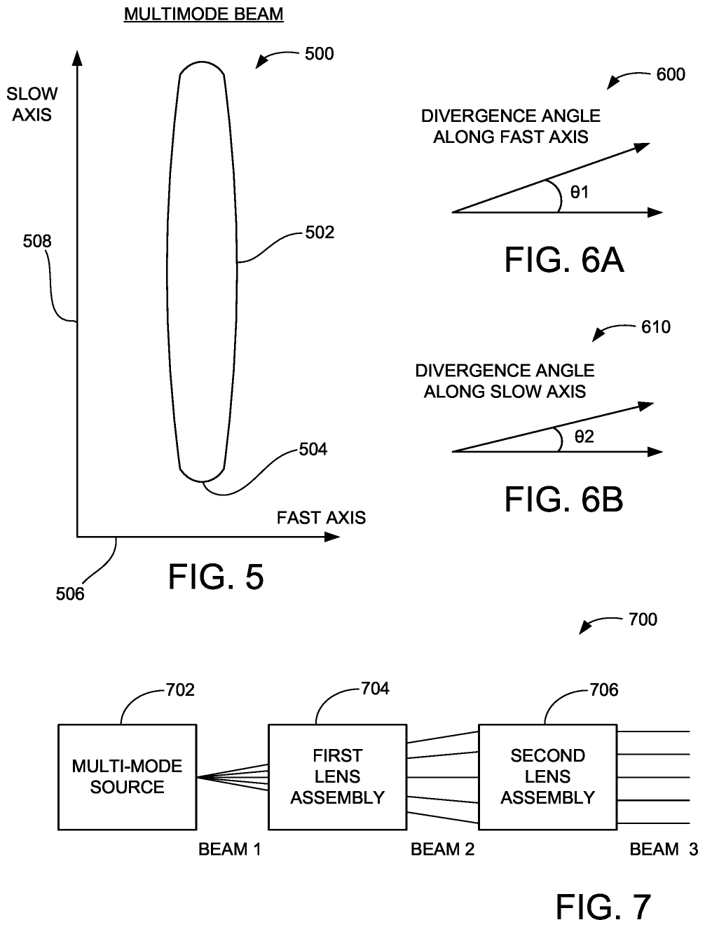

FIG. 5 is a simplified cross-sectional representation of a light beam (pulse) 500 emitted by an emitter such as in FIG. 3. The light beam can be characterized as a multimode beam or an elongated beam. The beam is largely oval/elliptical in shape, although other beam shapes can be emitted based on the configuration of the emitter. The beam 500 is shown to have opposing long sides 502 and opposing short ends 504.

As used herein, the term fast axis refers to the direction corresponding to the ends 504, as indicated by directional axis 506. The fast axis may can be thought of as being generally aligned with the width of the beam. The term slow axis refers to the sides 502 as indicated by orthogonal axis 508 and may be thought of as being generally aligned with the length of the beam. Other conventions can be used.

Beams such as 500 may be generated using semiconductor elements and may have a length to width aspect ratio of many multiples (e.g., 10:1, 20:1, etc.). This is not necessarily required, as the various embodiments of the present disclosure can be configured to compensation and control substantially any beam shape.

The beam 500 has different divergence angles along the respective fast and slow axes, as generally depicted in FIGS. 6A and 6B. More particularly, FIG. 6A shows the beam 500 to have a first divergence angle 600, denoted as angle θ1, along the ends 504 (fast axis). FIG. 6B shows the beam 500 to have a smaller second divergence angle 610, denoted as angle θ2, along the sides 502 (slow axis).

The actual and relative amounts of divergence can vary for different beam types, so FIGS. 5 and 6A-6B are not represented to scale and are merely illustrative. In one implementation, a beam corresponding to 500 has slow and fast axis emitted dimensions of about 180 micrometers, um (10⁻⁶ meters, m) by about 10 um and corresponding slow and fast divergence angles of about 0.3 degrees and 0.8 degrees. Other values and ranges can be used.

FIG. 7 is a functional block representation of a collimation optics system 700 constructed and operated in accordance with some embodiments. The system 700 can be incorporated into the various systems described above including but not limited to the emitters of FIGS. 1 and 3.

The system 700 includes a multi-mode source 702, a first optics assembly 704 and a second optics assembly 706. The multi-mode source 702 may be a modulated laser diode or some other form of electromagnetic radiation source that generates an initial beam (hereinafter “Beam 1”) such as the beam 500. The first optics assembly 704, also referred to herein as a first lens assembly, comprises one or more lenses to refract Beam 1 to output a second beam (Beam 2).

The second optics assembly 706, also referred to herein as a second lens assembly, similarly comprises one or more lenses to refract Beam 2 to output a final, third beam (Beam 3). Different rates of convergence and divergence are applied by the respective assemblies 704, 706 along the respective slow and fast axes so that the output Beam 3 is highly collimated to a selected level.

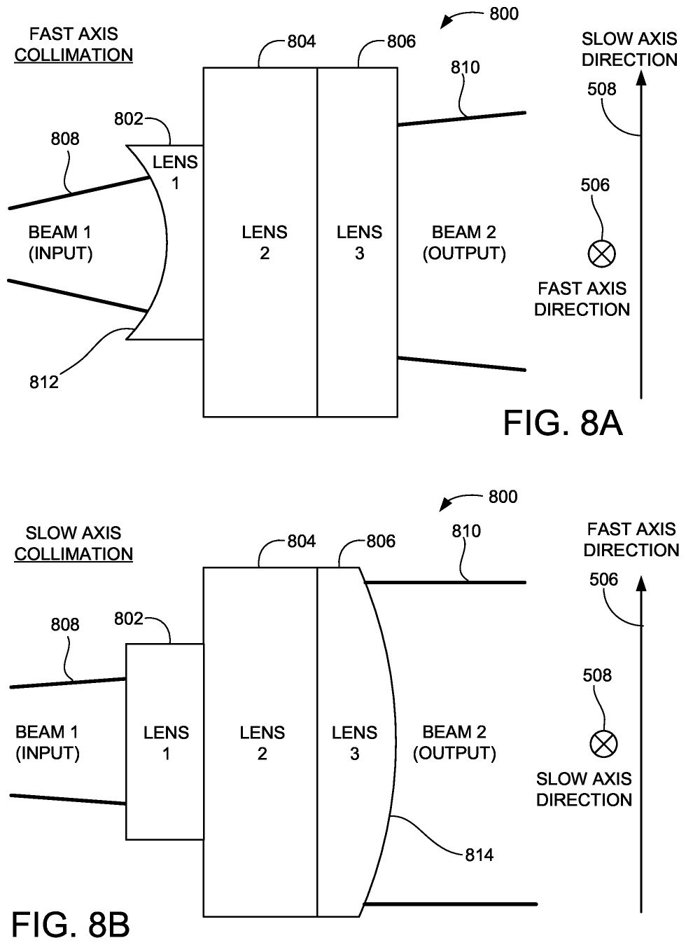

FIG. 8A shows a side elevational depiction of a first optics (lens) assembly 800 corresponding to the assembly 704 in some embodiments. Other arrangements can be used.

The optics assembly 800 includes three adjoined lenses 802, 804 and 806 denoted as Lens 1, Lens 2 and Lens 3. These lenses provide intervening interfaces that provide collimation of light power so that transformations occur from an input beam 808 (Beam 1) and an output beam 810 (Beam 2). Each lens 802, 804 and 806 is formed of a suitable refractive material such as glass, plastic, acrylic, etc. to provide desired refraction characteristics.

The respective lenses may be combined into a single multi-lens device through the use of intervening layers of adhesive or other adjoining mechanisms. While separate elements are shown, this is merely illustrative and is not limiting; for example, Lens 2 and Lens 3 can be a single unitary piece of material; grinding or other shaping processing can be used to form Lens 1 and Lens 2 from a single unitary piece of material, etc.

The first lens 802 (Lens 1) includes a curvilinearly extending surface 812 in facing relation toward a beam source (e.g., 702). The surface 812, also referred to herein as a first curvilinearly extending surface, is concave and in some embodiments is characterized as a cylindrical surface at a first radius of curvature. The surface 812 is sized and shaped to primarily provide collimation along the fast axis of the beam (506, FIG. 5) to initiate compensation for the associated divergence angle θ1 (FIG. 6A).

FIG. 8B is a top plan view of the assembly 800, so that FIG. 8B is rotated 90 degrees as compared to FIG. 8A. From this view it can be seen that the third lense 806 (Lens 3) has a second curvilinearly extending surface 814 in facing relation away from the beam source and the first curvilinearly extending surface 812. The second surface 814 is convex and also can be characterized as a cylindrical surface at different, second radius of curvature.

From FIGS. 8A and 8B it can be seen that the respective first and second surfaces 812, 814 are orthogonal to one another with surface 812 aligned along the fast axis 506 and surface 814 aligned along the slow axis 508. Stated another way, an imaginary cylinder of which the first surface 812 forms a part has a central axial line which is at an equal radius (radius of curvature) from the cylindrical surface, and this central axial line is parallel to the fast axis 506 (see FIG. 8A). Similarly, an imaginary cylinder that forms the second surface has a central axial line that is parallel to the slow axis 508 (see FIG. 8B).

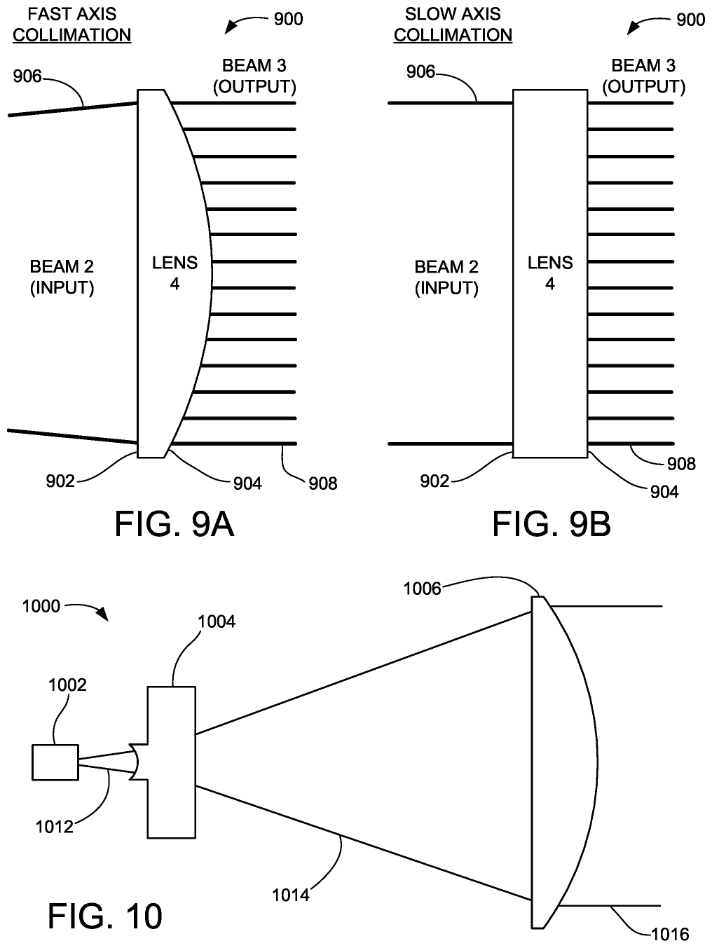

FIGS. 9A and 9B show corresponding orthogonal views of a second optics assembly 900 generally corresponding to the second optics assembly 706 in FIG. 7 in some embodiments. The assembly 900 is characterized as a fourth lens (Lens 4) with a flat surface 902 in facing relation toward the first optics assembly 800 and a curvilinearly extending surface 904 facing away from the first optics assembly 800.

The surface 904 is convex (cylindrical) at a third radius of curvature and is orthogonal to the second curvilinearly extending surface 814 so as to be aligned along the fast axis. In this way, further collimation is supplied along the fast axis in an input beam 906 (the end of Beam 2) to output a finally collimated beam (Beam 3) in both orthogonal fast and slow axes.

FIG. 10 is a schematic representation of another collimation optics system 1000 incorporating respective elements as described above in some embodiments. The system 1000 includes a multimode source 1002, first optics assembly 1004, and second optics assembly 1006 that respective act upon respective first, second and third beams (also referred to as beam segments or portions) 1012, 1014 and 1016. The output collimated beam can have any final desired cross-sectional shape and aspect ratio (e.g., square, rectilinear, curvilinear, etc.).

Those skilled in the art will recognize that collimation power is generally proportional to the output beam size; for a given source, generally the only conventional way to improve collimation with refractive optics is to use a bigger beam. This typically requires a longer distance between the source and the output lens, which can be prohibitive from a space and cost standpoint as well as for other considerations.

The various embodiments of the present disclosure provide a novel solution by providing the first lens assembly (e.g., 704, 800, 1004) with an initial diverging surface (e.g, cylindrical surface 812) in the other direction axis. In this way, two lens assemblies (800/900, 1004/1006) can be closely spaced together and used to collimate to virtually any desired specification in any given form factor.

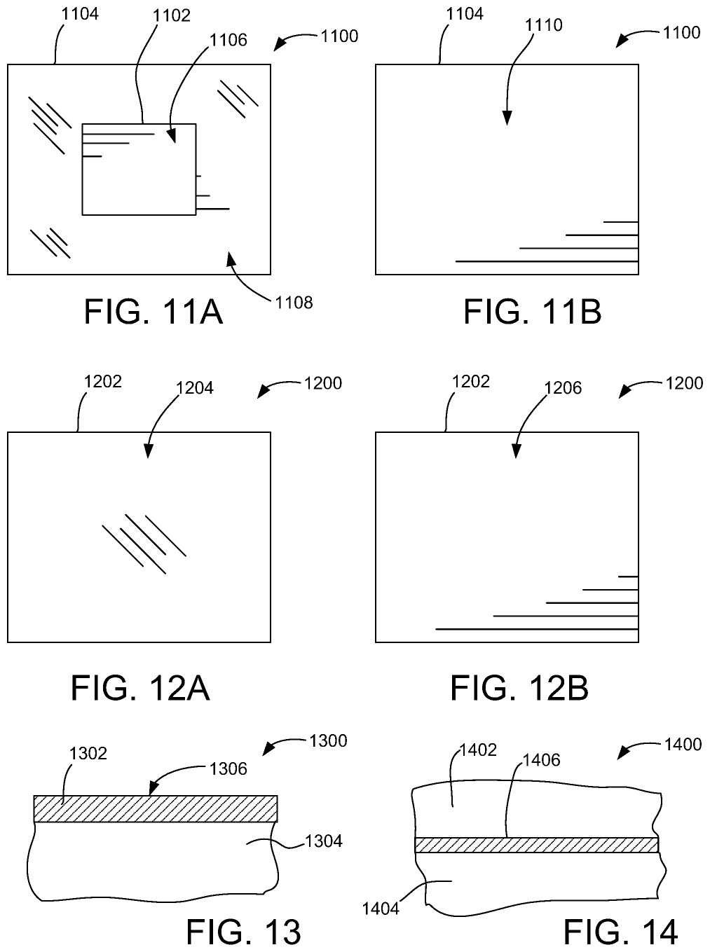

FIGS. 11A and 11B show further aspects of a first optics assembly 1100 in some embodiments in which a generally rectilinear shape for each of the respective lenses is used. Other shapes can be used (circular, elliptical, square, hexagonal, irregularly shaped, etc.). FIG. 11A shows a view facing the source (702, 1002) and FIG. 11B shows a view facing away from the source.

The assembly 1100 includes a first stage 1102 (corresponding to Lens 1 above) and a second stage 1104 (corresponding to Lens 2/3 above). The first stage 1102 has a concave cylindrical surface 1106 and the second stage 1104 has a flat facing surface 1108. It is contemplated that all of the beam emitted by the source (Beam 1) will impinge the cylindrical surface 1106, but such is not necessarily required. The cross-sectional area of the first stage 1102 can be extended to cover some or all of the surface 1108 as required. The second, convex cylindrical surface of the second stage 1104 is denoted at 1110.

At this point it will be recognized that the first lens assembly as variously embodied herein can be viewed as having a main body portion (e.g., stage 1104) with a first set of overall height, width and thickness dimensions. The second cylindrical surface 1110 extends over the respective height and width dimensions of this first set. The first lens assembly further has a projection (first stage 1102) that extends from the main body. The projection incorporates the first cylindrical surface 1106 and has a second set of overall height, width and thickness dimensions different from the first set. The first cylindrical surface 1106 extends over the respective height and width dimensions of this second set.

FIGS. 12A and 12B show corresponding front and rear facing views of a second optics assembly 1200 in some embodiments in which a generally rectangular shape for the lens 900, 1006 is utilized. As before, other cross-sectional shapes can be used. The assembly 1200 includes a lens 1202 (Lens 4) with a flat facing surface 1204 and a third convex, cylindrical surface 1206.

FIG. 13 shows a portion of another lens assembly 1300 that can be incorporated into the various embodiments described above. The assembly 1300 includes a surface coating layer 1302 applied to an underlying refractive substrate 1304. This provides a refractive surface 1306 into which the respective light beams pass. The layer can be any suitable material such as a polymer to provide controlled refractive characteristics as well as a protective coating for the underlying substrate.

FIG. 14 shows a portion of another lens assembly 1400 which can be incorporated into the various embodiments described above. The assembly 1400 includes respective refractive substrates 1402, 1404 adjoined using an intervening layer of adhesive 1406 or other adjoining material. As before, the layer 1406 can be provided with selected refractive characteristics that match or otherwise cooperate with the characteristics of the substrates 1402, 1404 to provide a final overall desired performance metric. The adhesive layer 1404 can be incorporated into the multi-lens arrangements described above for the first optics assembly as well as in other aspects of the system including a multi-lens arrangement for the second optics assembly.

It will now be understood that the various embodiments presented above provide a number of benefits, including controlled rates of divergence compensation along multiple orthogonal angles in a small form factor. The elements are easily manufactured and configured for different operational ranges of wavelengths, beam shapes and divergence angles, pulse shapes, etc.

While coherent, I/Q based systems have been contemplated as a basic environment in which various embodiments can be practiced, such are not necessarily required. Rather, any number of different types of systems can be employed, including solid state, mechanical, etc. The optics arrangements described herein are suitable for use in both emitters and detectors.

It is to be understood that even though numerous characteristics and advantages of various embodiments of the present disclosure have been set forth in the foregoing description, together with details of the structure and function of various embodiments of the disclosure, this detailed description is illustrative only, and changes may be made in detail, especially in matters of structure and arrangements of parts within the principles of the present disclosure to the full extent indicated by the broad general meaning of the terms in which the appended claims are expressed.

What is claimed is:

1. An apparatus, comprising:
a light source configured to output a light beam; and
a lens assembly configured to collimate the light beam for transmission to a distal target, the lens assembly formed of refractive material with a concave first cylindrical surface extending along a first axis in facing relation toward the light source and a convex, second cylindrical surface facing away from the light source and extending along a second axis orthogonal to the first axis.

2. The apparatus of claim 1, wherein the first cylindrical surface has a first radius of curvature and the second cylindrical surface has a larger, second radius of curvature.

3. The apparatus of claim 1, wherein the second cylindrical surface extends from a main body of the lens assembly with first overall height and width dimensions, and the first cylindrical surface extends from a projection portion that extends from the main body with smaller, second overall height and width dimensions.

4. The apparatus of claim 1, wherein the lens assembly is characterized as a multi-piece lens assembly comprising a first lens portion on which the first cylindrical surface is formed and a second lens portion on which the second cylindrical surface is formed, the first lens portion fixedly joined to the second lens portion.

5. The apparatus of claim 4, wherein the first lens portion is fixedly joined to the second lens portion via an intervening layer of adhesive that bonds the first lens portion to the second lens portion.

6. The apparatus of claim 4, wherein the first lens portion has a first refraction index and the second lens portion has a different, second refraction index.

7. The apparatus of claim 4, wherein the first lens portion has a first material composition and the second lens portion has a different, second material composition.

8. The apparatus of claim 1, wherein the light source is characterized as a multi-mode source which generates the light beam as an elongated beam having a first angle of divergence along a fast axis and a second angle of divergence along a slow axis, the first cylindrical surface aligned with the fast axis and the second cylindrical surface aligned with the slow axis.

9. The apparatus of claim 1, wherein the lens assembly is a first lens assembly, and wherein the apparatus further comprises a second lens assembly in spaced apart relation from the first lens assembly comprising refractive material configured to receive a portion of the light beam exiting the first lens assembly.

10. The apparatus of claim 9, wherein the first lens assembly is aligned between the light source and the second lens assembly such that a first intervening distance is provided between the light source and the first lens assembly and a larger, second intervening distance is provided between the first lens assembly and the second lens assembly.

11. The apparatus of claim 9, wherein the second lens assembly comprises a convex third cylindrical surface extending in facing away from the light source and extending along the first axis so as to be orthogonal to the second cylindrical surface.

12. The apparatus of claim 11, wherein the second lens assembly further comprises a nominally flat surface in facing relation toward the first lens assembly.

13. The apparatus of claim 9, wherein the respective first, second and third cylindrical surfaces each have a different radius of curvature.

14. The apparatus of claim 1, further comprising a beam steering mechanism configured to sweep the light beam across a field of view (FoV).

15. The apparatus of claim 14, further comprising a detector configured to receive reflected light from the swept light beam to decode range information associated with the target, the detector comprising a lens assembly having at least one concave or convex cylindrical surface.

16. A light detection and ranging (LiDAR) system, comprising:
an emitter configured to emit pulses of electromagnetic radiation against a target; and
a detector configured to receive reflected pulses of the electromagnetic radiation from the target to determine range information associated with the target, wherein the emitter comprises:
a multi-mode source configured to output the electromagnetic radiation in the form of a light beam;
a first lens assembly comprising a concave first cylindrical surface arranged in facing relation toward the light source to collimate the light beam along a fast axis and a convex, second cylindrical surface facing away from the light source and extending in a direction orthogonal to the first cylindrical surface to collimate the light beam along a slow axis; and
a second lens assembly comprising a concave third cylindrical surface facing away from the light source and extending in a direction orthogonal to the second cylindrical surface to collimate the light beam along the fast axis.

17. The system of claim 16, wherein the first optical lens assembly is formed of refractive material and the first and second cylindrical surfaces define opposing, outermost exterior boundary surfaces of the refractive material.

18. The system of claim 16, wherein each of the first, second and third cylindrical surfaces each has a different radius of curvature.

19. The system of claim 16, wherein the first optical lens assembly is formed of multiple lens affixed together in contacting relation and have a larger main body on which the second cylindrical surface extends and a smaller projection portion which extends from the larger main body on which the first cylindrical surface extends.

20. The system of claim 16, wherein the light beam has an elongated cross-sectional shape at an output position of the light source with respective length and width dimensions, wherein the length dimension is at least 10× the width dimension, and wherein the length dimension extends along the slow axis and the width dimension extends along the width dimension.
